(19) United States
(12) Patent Application Publication
(10) Pub. No.: US 2007/0053309 A1
(43) Pub. Date: Mar. 8, 2007

(54) Policy-Based Topology Maintenance for Wireless Networks that Employ Hybrid Tree-Based Routing with AODV

(75) Inventors: Neeraj Poojary, Sunnyvale, CA (US); Ariton Xhafa, Plano, TX (US); Shantanu Kangude, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/467,843

(22) Filed: Aug. 28, 2006

Related U.S. Application Data
(60) Provisional application No. 60/714,489, filed on Sep. 6, 2005.

(51) Int. Cl. H04L 12/28

(52) U.S. Cl. 370/256

(57) ABSTRACT

A mesh point operable in a decentralized wireless network is provided. The mesh point includes a transceiver and a processor. The transceiver is operable to communicate with other mesh points. The processor is programmed to execute a routing protocol such that, when a first policy of the routing protocol is selected and a transmission failure occurs between the mesh point and a current parent node of the mesh point, the processor is operable to execute instructions to promote finding another route to a root. The other route to the root is found by referencing a topology, if the topology is available, to identify the route to the root. If the route is not found, the transceiver transmits a one-hop broadcast route request. If the route is still not found, the mesh point enters a route discovery state.

### CROSS-REFERENCE TO RELATED APPLICATIONS

This application claims priority to and incorporates by reference U.S. Provisional Application No. 60/714,489, filed Sep. 6, 2005, entitled “Policy-Based Topology Maintenance for Wireless Networks that Employ Hybrid Tree-Based Routing with AODV”, Neeraj Poojary, et al. inventors.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The ability to access high speed and high performance data networks is becoming increasingly important to data clients. Wireless network access is needed in many areas where wired infrastructure is non-existent, outdated, or impractical. In some environments, fixed wireless broadband networks can perform this function. However, the effectiveness of fixed wireless broadband technology is limited due to a combination of technological constraints and high deployment costs. For example, each conventional Wireless Local Area Network (WLAN) technology access point must be connected directly to a wired backbone infrastructure.

To address the problem of access point tethering, mesh networks have been studied as an alternative. However, the effectiveness of wireless mesh networking is severely limited. In its most basic form, the mesh network is limited by its network capacity due to the requirement that nodes forward each others' packets. This forwarding of packets carries a corresponding increase in data overhead, making the mesh network inefficient. Finding ways to efficiently route traffic to minimize network overhead is, therefore, important in extending both the efficiency and the reliability of mesh networks.

### SUMMARY

According to one embodiment, the disclosure provides a mesh point operable in a decentralized wireless network. The mesh point comprises a transceiver and a processor. The transceiver is operable to communicate with other mesh points. The processor is programmed to execute a routing protocol such that, when a first policy of the routing protocol is selected and a transmission failure occurs between the mesh point and a current parent node of the mesh point, the processor is operable to execute instructions to promote finding another route to a root. The other route to the root is found by referencing a topology, if the topology is available, to identify the route to the root. If the route is not found, the transceiver transmits a one-hop broadcast route request. If the route is still not found, the mesh point enters a route discovery state.

Another embodiment of the disclosure provides a data: signal embodied in a carrier wave. The data signal is operable to promote execution of a routing protocol by a mesh point in a decentralized network. The routing protocol comprises, when a first policy of the routing protocol is selected and a transmission failure occurs between the mesh point and a current parent node of the mesh point, a processor is operable to execute instructions to promote finding another route to a root. The other route to the root is found by referencing a topology, if the topology is available, to identify the route to the root. If the route is not found, the transceiver transmits a one-hop broadcast route request. If the route is still not found, the mesh point enters a route discovery state.

Yet another embodiment of the disclosure provides a method of communicating in a decentralized wireless network. The method comprises, when a first policy of a routing protocol is selected and a transmission failure occurs, attempting to find another route to a root. The other route to the root is found by referencing a topology, if the topology is available, to identify the route to the root. If the route is not found, a one-hop broadcast route request is transmitted. If the route is still not found, a route discovery state is entered. The method further comprises, when a second policy of the routing protocol is selected, periodically verifying that a mesh point is in communication with a current parent node of the mesh point, and when the mesh point cannot communicate with the current parent node of the mesh point, finding another route to the root. The other route to the root is found by referencing a topology, if the topology is available, to identify the route to the root. If the mute is not found, a one-hop broadcast route request is transmitted. If the route is still not found, a route discovery state is entered. The method further comprises, when a third policy of the routing protocol is selected, substantially implementing the second policy of the routing protocol and periodically transmitting a one-hop route request to find a different route to the root, and when it is determined to use the different route to the root, transmitting to the root the different route to the root to be used. The method further comprises, when a fourth policy of the routing protocol is selected, substantially implementing the third policy of the routing protocol and transmitting to downstream mesh points the different route to the root being used.

These and other features and advantages will be more clearly understood from the following detailed description taken in conjunction with the accompanying drawings and claims.

### BRIEF DESCRIPTION OF THE DRAWINGS

For a more complete understanding of the disclosure and the advantages thereof, reference is now made to the following brief description, taken in connection with the accompanying drawings and detailed description, wherein like reference numerals represent like parts.

FIG. 1 illustrates an exemplary general-purpose wireless mesh network suitable for implementing an embodiment of the disclosure.

FIG. 2 illustrates a method of communicating in a decentralized wireless network according to an embodiment of the disclosure.

FIG. 3 illustrates an exemplary general purpose computer system suitable for implementing the several embodiments of the disclosure.

### DETAILED DESCRIPTION

It should be understood at the outset that although an exemplary implementation of one embodiment of the disclosure is illustrated below, the system may be implemented using any number of techniques, whether currently known or in existence. The disclosure should in no way be limited to the exemplary implementations, drawings, and techniques illustrated below, including the exemplary design and implementation illustrated and described herein, but may be modified within the scope of the appended claims along with their full scope of equivalents.

In the routing of traffic in a wireless mesh network, a tradeoff sometimes exists between creating a path with optimum routing efficiency and creating a path with minimum maintenance overhead. A routing protocol that consistently causes data packets to take a highly efficient path may require a great deal of communication and coordination among the nodes in the network to maintain routing information. On the other hand, less coordination, and therefore less maintenance-related network traffic, may be needed if data packets are allowed to take less efficient paths.

Embodiments of the disclosure provide policies that allow a network's operating parameters to be tuned to the goals for the network. If the network needs highly efficient data routing, a proactive, high-maintenance policy can be enforced. If network maintenance-related traffic needs to be minimized, a more reactive, lower maintenance policy can be imposed. In an embodiment, four policies with varying levels of routing efficiency and maintenance overhead can be implemented. This allows a consistent topology maintenance framework to be imposed on different types of wireless mesh networks.

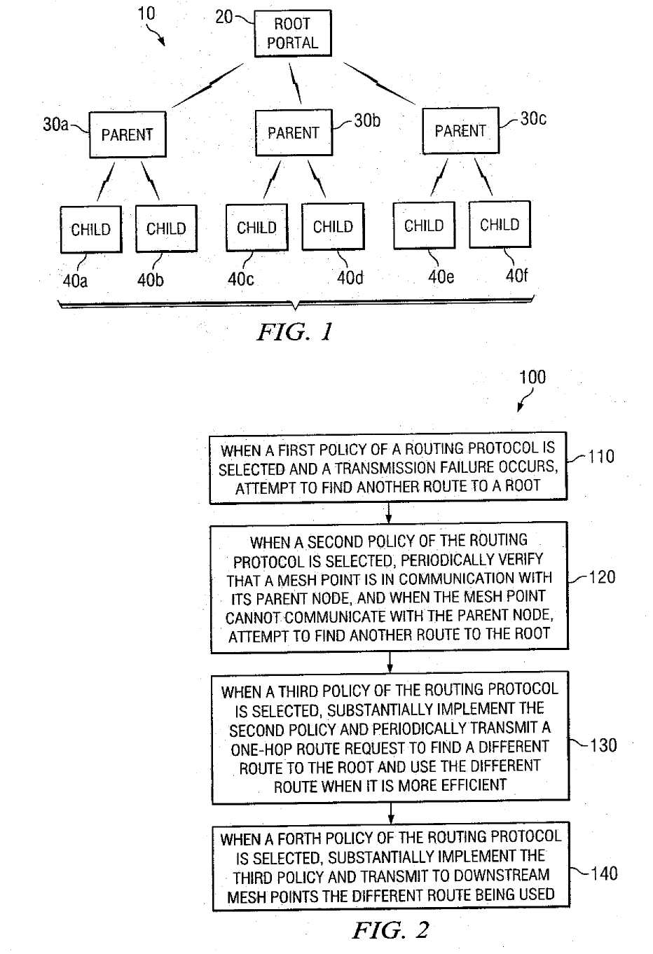

FIG. 1 illustrates an example of a wireless mesh network 10 on which these topology maintenance policies might be implemented. The network 10 includes a plurality of nodes, which might be mesh points, access points, combination mesh/access points, computers, laptop computers, portable computers, servers, other systems associated with mesh or access points, or other components that might be implemented in decentralized networks. Each node will include a transceiver capable of wirelessly sending and receiving data packets. A connection to a terrestrial network and/or a wired network may also be present but is not illustrated.

A root portal 20 acts as a parent to all other nodes in the network 10. A first parent node 30a, second parent node 30b, and third parent node 30c can communicate wirelessly with the root portal 20. In other embodiments, other numbers of parent nodes 30 could be present. Parent node 30a can communicate wirelessly with child nodes 40a and 40b, parent node 30b can communicate wirelessly with child nodes 40c and 40d, and parent node 30c can communicate wirelessly with child nodes 40e and 40f. A route from one of the child nodes 40 to one of the parent nodes 30; to the root portal 20 will be referred to herein as an upstream route and a route from the root portal 20 to one of the parent nodes 30 to one of the child nodes 40 will be referred to herein as a downstream route.

In other embodiments, other numbers of child nodes 40 could communicate with the each parent node 30. Also, in other embodiments, additional layers of nodes could be present such that a node may act as a parent to downstream nodes and as a child to upstream nodes. For example, one or more of the child nodes 40 could act as a parent node to one or more further downstream child nodes, which could have child nodes of their own, and so on.

When a network such as the network 10 is initially set up, a topology discovery and formation phase may occur during which it is determined which child nodes 40 will be associated with which parent nodes 30. The topology discovery and formation phase might follow an automated algorithm or might be conducted manually by a network administrator. When the topology discovery and formation phase is complete, each node will send upstream data to only one upstream node.

For instance, the topology discovery and formation phase might establish that, when child node 40a, for example, wishes to communicate with child node 40c, for example, child node 40a should send a data packet to parent node 30a, which should send the packet to the root portal 20. The root portal 20 would then send the packet to parent node 30b, which would send the packet to child node 40c. One of skill in the art will recognize that the topology discovery and formation phase might establish other routes among the illustrated nodes or among other nodes not shown.

One of skill in the art will also recognize that the topology of FIG. 1 is a tree-based structure. The embodiments of the disclosure focus on such a topology and, more specifically, on a tree-based structure that uses the Ad Hoc On Demand Distance Vector (AODV) routing protocol. Such a routing procedure is described in the Institute of Electrical and Electronics Engineers (IEEE) draft standard 802.11s for the hybrid wireless mesh protocol (HWMP), which is incorporated herein by reference. However, the embodiments described herein should not be limited to such a topology and such a routing protocol and could, with minimal modifications apparent to one of skill in the art, be applicable in other environments, protocols, and networks. Additional information about such networks and protocols is in U.S. patent application Ser. No. 11/432,124, filed May 11, 2006, entitled “Quality of Service Aware Robust Link State Routing for Mesh Networks”, Ariton Xhafa, et al. inventors, and U.S. patent application Ser. No. 11/436,835, fled May 18, 2006, entitled “Routing Switch for Parameterized Routing in Mesh Networks”, Ariton Xhafa, et al. inventors, both of which are incorporated herein by reference for all purposes.

When a first child node 40, child node 40a for example, attempts to communicate with a second child node 40, child node 40c for example, the communication could fail because the child node 40a is unable to communicate with its parent node 30a or because some other fault exists in the route from the child node 40a to the root portal 20. When such a communication failure occurs, the child node 40a might attempt to find another route through which to reach the root portal 20. When an alternative route is found, the topology of the network 10 might be reconfigured to reflect the new route. For example, if the child node 40a were to discover a route to the root portal 20 through parent node 30c rather than through parent 30a, the network 10 might be reconfigured to reflect that child node 40a has become a child of parent node 30c.

In an embodiment, the four topology maintenance policies that can be imposed on the network 10 differ in the manners in which the child nodes 40 determine whether a valid communication route exists and in when and how the child nodes 40 determine alternative communication routes. The four policies can be referred to as policy 4, policy 3, policy 2, and policy 1, in order of increasing routing efficiency and increasing maintenance overhead.

Policy 4 has the least routing optimality and the least maintenance overhead. In policy 4, the child nodes 40 do not initiate any proactive maintenance procedures. That is, the child nodes 40 do not attempt to determine whether a valid communication route exists prior to attempting to communicate. Instead, the child nodes 40 wait until they have data to forward and then send the data to their parent nodes 30 without any knowledge of whether the data will reach the root portal 20. If the data reaches the root portal 20, no change to the topology of the network 10 is made. If the child node 40 is unable to communicate with its parent node 30 or if a routing error message is generated because of a communication failure at some point between the parent node 30 and the root portal 20, the child node 40 attempts to discover an alternative route to the root portal 20.

In an embodiment, a three-step procedure is followed to determine the alternative route. In the first step, if a list of potential parent nodes 30 had been stored in a topology discovery and formation phase, the child node 40 will attempt to revalidate a route to the root portal 20 through each of the potential parent nodes 30 by sending a route request to each of the potential parent: nodes 30. Each potential parent node 30 with a valid route to the root portal 20 will respond to the route request with a route reply. The child node 40 will then select one of the potential parent nodes 30 using a known selection protocol. One appropriate protocol is described below.

If no potential parent nodes 30 had been stored or if no valid route to the root portal 20 is found through one of the potential parent nodes 30, the second step in the three-step procedure is followed. In this step, the child node 40 transmits a one-hop broadcast route request to attempt to find an appropriate parent node 30 through which to transmit data. If responses to the one-hop broadcast route request are received, the child node 40 might attempt to validate the routes referred to by the route responses and might select a route to the root portal 20 from one of the validated routes.

If no responses to the one-hop broadcast route request are received or if a route to the root portal 20 is not validated from among the responses, the third step in the three-step procedure is followed. In this step, the child node 40 enters a root discovery state similar to the original topology discovery and formation phase mentioned above.

Policy 3 has a greater degree of routing optimality and greater maintenance overhead than policy 4. In policy 3, the child nodes 40 transmit periodic maintenance route requests to their parent nodes 30 to determine if valid communication routes exist between the child nodes 40 and the root portal 20. If route responses are received indicating that valid routes exist, no changes are made to the topology of the network 10 and the child nodes 40 continue to communicate with the parent nodes 30 with which the child nodes 40 had previously been communicating.

If, after a predefined number of route requests, the child node 40 does not receive a route response with a valid route to the root portal 20, or if the child node 40 receives a route error message from its parent node 30, or if the child node 40 is unable to communicate with its parent node 30, the child node 40 will attempt to find an alternative route to the root portal 20 using the three-step procedure described above. When an alternative route is found, the network 10 is reconfigured to incorporate the new route from the child node 40 to the root portal 20.

Policy 2 has a greater degree of routing optimality and greater maintenance overhead than policy 3. In policy 2, the child nodes 40 transmit periodic maintenance route requests to their parent nodes 30 as in policy 3 and the child nodes 40 follow subsequent procedures similar to those described for policy 3 based on the results of transmitting the periodic maintenance route requests. In addition, the child nodes 40 periodically broadcast one-hop route requests to determine if a more efficient route to the root portal 20 exists. The one-hop route requests might be transmitted more frequently than the maintenance route requests. If a route response to the one-hop route requests is received that indicates that a route to the root portal 20 through a different parent node 30 is more efficient than the route through the current parent node 30, the different parent node 30 is made the parent of the child node 40. An unsolicited route response might be sent from the child node 40 to the root portal 20 through the different parent node 30 to confirm the change in network topology.

Policy 1 encompasses all of the procedures followed in policy 2. In addition, policy 1 specifies that when any change occurs in the route from the child node 40 to the root portal 20, the child node 40 informs any nodes that are downstream from the child node 40 of the change. The downstream nodes could then make appropriate changes in their data traffic routes to take the upstream changes into account.

Only one of the four policies would typically apply to the network 10 at any one time. An appropriate policy might be implemented in the root portal 20 when the network 10 is originally configured or is reconfigured or when a network administrator determines that a policy change is needed. The root portal 20 might then advertise which policy is in place so that existing nodes and new nodes joining the network 10 will be aware of which policy should be followed. The root portal 20 might transmit information regarding the current policy in a beacon or a similar maintenance signal typically used in wireless mesh networks. Upon receiving the beacon, each node might transmit its own beacon advertising the current policy. Thus, a new node might receive policy information from the root portal 20 or from another node.

A network administrator or other person responsible for maintaining the network 10 could easily change the policy in effect on the network 10 by making the appropriate changes in the root portal 20. The policy change would then propagate throughout the network 10. The policy that is appropriate for the network 10 could be determined based on the network managers judgment, which might be based on the type and amount of traffic on the network 10, the quality of service requirements for the network 10, the bandwidth of each node, and other considerations.

When a connection failure occurs between one of the child nodes 40 and its parent node 30 and several potential new parent nodes exist to which the child node 40 could connect, the child node 40 might select a new parent node in one of several different ways. A protocol that uses Quality of Service (QoS) parameters to determine a new parent node may be found in U.S. patent application Ser. No. 11/432,124 entitled “Quality of Service Aware Robust Link State Routing For Mesh Network, inventors Xhafa et al., Docket No. (TI-60530)(1962-35200), filed on May 11, 2006, which was incorporated above by reference. QoS parameters may include, but are not limited to, signal strength, battery status, signal to noise ratio, jitter, and delay. In other embodiments other procedures for selecting a new parent node could be used.

FIG. 2 illustrates a method 100 of communicating in a decentralized wireless network. In box 110, when a first policy of a routing protocol is selected and a transmission failure occurs, another route to a root is sought. In box 120, when a second policy of the routing protocol is selected, it is periodically verified that a mesh point is in communication with its parent node and, when the mesh point cannot communicate with the parent, another route to the route is sought. In box 130, when a third policy of the routing protocol is selected, the second policy is substantially implemented and a one-hop route request is periodically transmitted to find a different route to the root and the different route is used when the different route is more efficient than the current route. In box 140, when a fourth policy of the routing protocol is selected, the third policy is substantially implemented and the different route being used is transmitted to downstream mesh points.

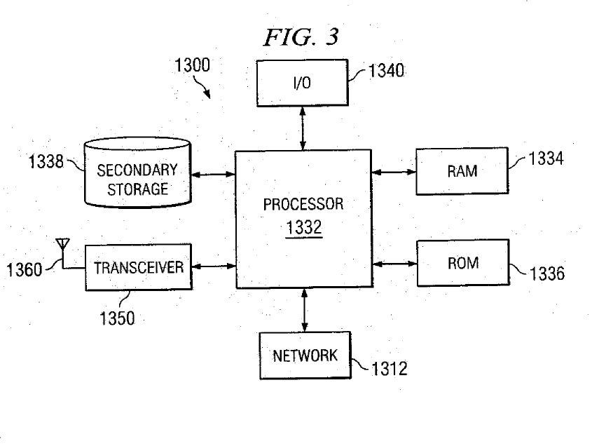

The nodes described above may be implemented on any general-purpose computer with sufficient processing power, memory resources, and network throughput capability to handle the necessary workload placed upon it. FIG. 3 illustrates a typical, general-purpose computer system 1300 suitable for implementing one or more embodiments disclosed herein, including operating as a network node. The computer system 1300 includes a processor 1332 (which may be referred to as a central processor unit or CPU) that is in communication with memory devices including secondary storage 1338, read only memory (ROM) 1336, random access memory (RAM) 1334, input/output (I/O) devices 1340, and network connectivity devices 1312. The processor 1332 may be implemented as one or more CPU chips.

The secondary storage 1338 is typically comprised of one or more disk drives or tape drives and is used for non-volatile storage of data and as an overflow data storage device if the RAM 1334 is not large enough to hold all working data. Secondary storage 1338 may be used to store programs which are loaded into the RAM 1334 when such programs are selected for execution. The ROM 1336 is used to store instructions and perhaps data which are read during program execution. The ROM 1336 is a non-volatile memory device which typically has a small memory capacity relative to the larger memory capacity of the secondary storage 1338. The RAM 1334 is used to store volatile data and perhaps to store instructions. Access to both ROM 1336 and RAM 1334 is typically faster than to secondary storage 1338.

I/O devices 1340 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 1312 may take the form of modems, modem banks, ethernet cards, universal serial bus (USB) interface cards, serial interfaces, token ring cards, fiber distributed data interface (FDDI) cards, wireless local area network (WLAN) cards, ultra-wideband (UWB) cards, radio transceiver cards such as code division multiple access (CDMA) and/or global system for mobile-communications (GSM) radio transceiver cards, and other well-known network devices. These network connectivity devices 1312 may enable the processor 1332 to communicate with the Internet or one or more intranets. With such a network connection, it is contemplated that the processor 1332 might receive information from the network, or might output information to the network in the course of performing the above-described method steps. Such information, Which is often represented as a sequence of instructions to be executed using the processor 1332, may be received from and outputted to the network, for example, in the form of a computer data signal embodied in a carrier wave.

Such information, which may include data or instructions to be executed using the processor 1332 for example, may be received from and outputted to the network, for example, in the form of a computer data baseband signal or signal embodied in a carrier wave. The baseband signal or signal embodied in the carrier wave generated by the network connectivity devices 1312 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 1332 executes instructions, codes, computer programs, and scripts which it accesses from hard disk, floppy disk, optical disk (these various disk-based systems may all be considered secondary storage 1338), ROM 1336, RAM 1334, or the network connectivity devices 1312.

The computer system 1300 might also include a transceiver 1350 and an antenna 1360 to support wireless transmission and reception of data. The transceiver 1350 and antenna 1360 might have the capability to convert signals transmitted wirelessly to signals transmitted over a solid medium and vice versa.

While several embodiments have been provided in the disclosure, it should be understood that the disclosed systems and methods may be embodied in many other specific forms without departing from the spirit or scope of the disclosure. The examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A mesh point operable in a decentralized wireless network, comprising:
a transceiver operable to communicate with other mesh points;
a processor programmed to execute a routing protocol, when a first policy of the routing protocol is selected and a transmission failure occurs between the mesh point and a current parent node of the mesh point, the processor is operable to execute instructions to promote finding another route to a root by:
referencing a topology, if the topology is available, to identify the route to the root,
and if the route is not found, the transceiver transmitting a one-hop broadcast route request,
and if the route is not found, the mesh point entering a route discovery state.

2. The mesh point of claim 1, further comprising when a second policy of the routing protocol is selected, the processor is operable to execute instructions to promote the transceiver periodically verifying that the mesh point is in communication with the current parent node of the mesh point, and when the mesh point cannot communicate with the current parent node of the mesh point then the processor is operable to find another route to the root by:
referencing a topology, if the topology is available, to identify the route to the root,
and if the route is not found, the transceiver transmitting a one-hop broadcast route request,
and if the route is not found, the mesh point entering a route discovery state.

3. The mesh point of claim 2, further comprising when a third policy of the routing protocol is selected, the processor is operable to execute instructions substantially implementing the second policy of the routing protocol and further to promote the transceiver periodically transmitting a one-hop route request to find a different route to the root, and when the mesh point determines to use the different route to the root, the transceiver transmitting to the root the different route to the root to be used by the mesh point.

4. The mesh point of claim 3, further comprising when a fourth policy of the routing protocol is selected, the processor is operable to execute instructions substantially implementing the third policy of the routing protocol and further to promote the transceiver transmitting to downstream mesh points the different route to the root being used by the mesh point.

5. The mesh point of claim 3, wherein when the third policy is selected the different route is further defined as a more efficient route to the root.

6. The mesh point of claim 3, wherein when the third policy is selected the different route is further defined as an optimal route to the root.

7. The mesh point of claim 1, wherein the mesh point is further defined as at least one of:
an access point;
a root;
a combination mesh point/access point;
a computer;
a laptop computer;
a portable computer;
a wireless handset; and
a server computer.

8. The mesh point of claim 1, wherein finding another route to the root includes:
referencing a topology, if the topology is available, to identify the route to the root;
if identifying the route to the root by referencing the topology fails, then next, the transceiver transmitting a one-hop broadcast route request; and
if identifying the route to the root by transmitting the one-hop broadcast route request fails, then next, the mesh point entering a route discovery state.

9. The mesh point of claim 4, wherein one of the first policy, the second policy, the third policy, and the fourth policy is selected at least one of:
a time when the network is initially configured;
a time when at least one parameter of the network changes; and
a time when a different policy is desired.

10. A data signal embodied in a carrier wave, the data signal operable to promote execution by a mesh point in a decentralized network of a routing protocol comprising:
when a first policy of the routing protocol is selected and a transmission failure occurs between the mesh point and a current parent node of the mesh point, a processor is operable to execute instructions to promote finding another route to a root by:
referencing a topology, if the topology is available, to identify the route to the root,
and if the route is not found, the transceiver transmitting a one-hop broadcast route request,
and if the route is not found, the mesh point entering a route discovery state.

11. The data signal of claim 10, wherein the routing protocol further comprises, when a second policy of the routing protocol is selected, the processor is operable to execute instructions to promote the transceiver periodically verifying that the mesh point is in communication with the current parent node of the mesh point, and when the mesh point cannot communicate with the current parent node of the mesh point then the processor is operable to find another route to the root by:
referencing a topology, if the topology is available, to identify the route to the root,
and if the route is not found, the transceiver transmitting a one-hop broadcast route request,
and if the route is not found, the mesh point entering a route discovery state.

12. The data signal of claim 11, further comprising when a third policy of the routing protocol is selected, the processor is operable to execute instructions substantially implementing the second policy of the routing protocol and further to promote the transceiver periodically transmitting a one-hop route request to find a different route to the root, and when the mesh point determines to use the different route to the root, the transceiver transmitting to the root the different route to the root to be used by the mesh point.

13. The data signal of claim 12, further comprising when a fourth policy of the routing protocol is selected, the processor is operable to execute instructions substantially implementing the third policy of the routing protocol and further to promote the transceiver transmitting to downstream mesh points the different route to the root being used by the mesh point.

14. The data signal of claim 12, wherein when the third policy is selected the different route is further defined as a more efficient route to the root.

15. The data signal of claim 12, wherein when the third policy is selected the different route is further defined as an optimal route to the root.

16. The data signal of claim 10, wherein the mesh point is further defined as at least one of:
an access point;
a root;
a combination mesh point/access point;
a computer;
a laptop computer;
a portable computer; and
a server computer.

17. The data signal of claim 10, wherein finding another route to the root includes:
referencing a topology, if the topology is available, to identify the route to the root;
if identifying the route to the root by referencing the topology fails, then next, the transceiver transmitting a one-hop broadcast route request; and
if identifying the route to the root by transmitting the one-hop broadcast route request fails, then next, the mesh point entering a route discovery state.

18. The data signal of claim 13, wherein one of the first policy, the second policy, the third policy, and the fourth policy is selected at least one of:
a time when the network is initially configured;
a time when at least one parameter of the network changes; and
a time when a different policy is desired.

19. A method of communicating in a decentralized wireless network, comprising:
when a first policy of a routing protocol is selected and a transmission failure occurs, attempting to find another route to a root by:
referencing a topology, if the topology is available, to identify the route to the root,
and if the route is not found, transmitting a one-hop broadcast route request,
and if the route is not found, entering a route discovery state;
when a second policy of the routing protocol is selected, periodically verifying that a mesh point is in communication with a current parent node of the mesh point, and when the mesh point cannot communicate with the current parent node of the mesh point, finding another route to the root by:
referencing a topology, if the topology is available, to identify the route to the root,
and if the route is not found, transmitting a one-hop broadcast route request,
and if the route is not found, entering a route discovery state;
when a third policy of the routing protocol is selected, substantially implementing the second policy of the routing protocol and periodically transmitting a one-hop route request to find a different route to the root, and when it is determined to use the different route to the root, transmitting to the root the different route to the root to be used; and
when a fourth policy of the routing protocol is selected, substantially implementing the third policy of the routing protocol and transmitting to downstream mesh points the different route to the root being used.

20. The method of claim 19, wherein when the third policy is selected the different route is further defined as a more efficient route to the root.
